(19) United States
(12) Patent Application Publication
(10) Pub. No.: US 2019/0115615 A1
(43) Pub. Date: Apr. 18, 2019

(54) FABRICATION METHOD OF COMPOSITE MATERIAL BASED ON CATHODE ACTIVE MATERIAL AND SOLID ELECTROLYTE, AND FABRICATION METHOD OF CATHODE FOR ALL SOLID CELL INCLUDING THE SAME

(71) Applicants: Hyundai Motor Company, Seoul (KR); Kia Motors Corporation, Seoul (KR); IUCF-HYU (Industry-University Cooperation Foundation Hanyang University), Seoul (KR)

(72) Inventors: Oh Min Kwon, Busan (KR); Yong Sub Yoon, Seoul (KR); Sung Woo Noh, Seoul (KR); Sun Ho Choi, Incheon (KR); Jong Yeob Park, Seoul (KR); Dong Wook Shin, Seongnam (KR); Chan Hwi Park, Seoul (KR)

(21) Appl. No.: 15/845,061

(22) Filed: Dec. 18, 2017

(30) Foreign Application Priority Data
Oct. 13, 2017 (KR) 10-2017-0133339

(51) Int. Cl. H01M 10/052; H01M 4/136; H01M 4/58

(52) U.S. Cl. CPC H01M 10/052; H01M 4/58; H01M 4/136

(57) ABSTRACT

Provided are a method of fabricating a composite material and a method of fabricating a cathode for an all solid cell including the same. The method of fabricating the solid electrolyte composite material may include a cathode active material as a core and a solid electrolyte as a shell.

### CROSS-REFERENCE TO RELATED APPLICATION

This application claims under 35 U.S.C. §119(a) the benefit of Korean Patent Application No. 10-2017-0133339 filed Oct. 13, 2017, the entire contents of which are incorporated herein by reference.

### TECHNICAL FIELD

The present invention relates to a method of fabricating a composite material that may be used as a cathode active material and a solid electrolyte and a method of fabricating a cathode for an all solid cell including the same. The method may provide a composite material comprising a cathode active material as a core and a solid electrolyte as a shell.

### BACKGROUND

Recently, interest in an all solid cell capable of enhancing charge/discharge efficiency has increased. Among the all solid cells, in a lithium-sulfur all solid cell, it is important for the cell efficiency to fabricate a composite cathode that efficiently forms a lithium ion channel between a Li₂S cathode active material and a solid electrolyte. However, by a simple mixing process, the cathode active material and the solid electrolyte may be unevenly mixed depending on different particle sizes and shapes, and an interface between the cathode active material and the solid electrolyte may not be uniformly formed, and thus the performance of the cell may be deteriorated.

In the related art, a method for fabricating a cathode for a lithium-sulfur battery by impregnating sulfur into a conductive material of the cathode has been disclosed, but the method may be selectively applied only to a linear conductive material.

The above information disclosed in this Background section is only for enhancement of understanding of the background of the invention and therefore it may contain information that does not form the prior art that is already known in this country to a person of ordinary skill in the art.

### SUMMARY OF THE INVENTION

In preferred aspects, the present invention provides a method of fabricating a composite material including a cathode active material and a solid electrolyte and capable of maintaining performance of a cell by forming uniformly an interface between the cathode active material and the solid electrolyte. Accordingly, a charge/discharge capacity of the cell including the composite material may be improved by increasing a contact area between the cathode active material and the solid electrolyte, and increasing the content of the cathode active material compared to a unit area of the cathode.

Additionally, the present invention provides a method of fabricating a cathode for an all solid cell using the composited material as described herein.

In one aspect, provided is a method of fabricating a composite material including a cathode active material and a solid electrolyte. The method may include: preparing an admixture comprising 1) Li₂S, and P₂S₅, and 2) a solvent component, wherein the P₂S₅ is admixed in the solvent component; drying the admixture, wherein a portion of the Li₂S forms particles and a remaining portion of the Li₂S and the P₂S₅ form a coating layer on a surface of the Li₂S particles; and heat-treating the Li₂S particles formed with the coating layer such as at a temperature of about 200 to 600° C. to form the composite material, wherein the composite material has a core-shell structure and comprises the Li₂S particles as a core and at least one of Li₇P₃S₁₁, Li₃PS₄, and Li₄P₂S₆ as a shell.

The solvent component may suitably include one or more polar solvent.

The polar solvent may suitably be an alcohol such as 1-propanol, ethanol and methanol, an ester such as alkyl acetate (e.g., ethyl acetate), or an amide such as formamide.

The portion of the Li₂S forming the particles may suitably be 55 wt % or greater, 60 wt % or greater, 65 wt % or greater, 70 wt % or greater, 75 wt % or greater, 80 wt % or greater, 85 wt % or greater, 90 wt % or greater, 95 wt % or greater, or 99 wt % or greater of the total weight of the Li₂S in the composite material.

A wt % ratio of Li₂S and P₂S₅ in the admixture may suitably be from about 90:10 to about 99:1, more typically from about 92:8 to about 95:5.

The admixture may be prepared by stirring the solvent component, Li₂S and P₂S₅ at a temperature of about 30 to 60° C. for about 5 to 24 hours.

The admixture may further include LiCl, and the P₂S₅ and the LiCl may be admixed in the solvent component. Likewise, the coating layer including the Li₂S, the P₂S₅, and the LiCl may be suitably formed on the surface of the Li₂S particles. Accordingly, the composite material may suitably include the Li₂S particles as a core and at least one of the Li₇P₃S₁₁, the Li₃PS₄, the Li₄P₂S₆, and Li₆PS₅Cl as a shell.

Preferably, the core of the composite material may include a cathode active material and the shell of the composite material may include a solid electrolyte.

In another aspect, the present invention provides a fabrication method of a cathode for an all solid cell. The method may include: providing the composite material fabricated by the method as described herein; and mixing a conductive material with the composite material.

Preferably, the conductive material may be mixed with the composite material at a wt % ratio from about 1:0.3 to about 2:0.3.

Also provided is an all-solid battery comprising a composite material as described herein.

According to various exemplary embodiment of the present invention, the method may provide the composite material comprising on the cathode active material, for example, as a core, and the solid electrolyte, as a shell. As such, performance of a cell by forming uniformly an interface between the cathode active material and the solid electrolyte may be maintained, a charge/discharge capacity of the cell may be improved by increasing a contact area between the cathode active material and the solid electrolyte, and the content of the cathode active material compared to a unit area of the cathode may increase.

Also provide are composite materials obtainable by or obtained from the method described herein. Further provided are cathodes that include the composite material as described herein and the conductive material such as carbon. Still further provided are all-solid batteries that include composite materials and/or cathodes as described herein. Moreover, provided are vehicles that include the composite materials, cathodes, or all-solid batteries as described herein.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1A is an exemplary method of fabricating an exemplary cathode for an all solid cell (e.g., all-solid battery) according to an exemplary embodiment of the present invention;

FIG. 1B is an exemplary method of method of fabricating a composite material including a cathode active material and a solid electrolyte according to an exemplary embodiment of the present invention;

FIGS. 2A, 2B, and 2C illustrate cross-sectional views along with sequential steps of an exemplary method of fabricating an exemplary composite material according to an exemplary embodiment of the present invention;

FIG. 3A is a graph illustrating a relationship between the charge/discharge cycle number and a capacity and a relationship between the charge/discharge cycle number and coulombic efficiency in Example 1 and Comparative Example 1, respectively;

FIG. 3B is a graph illustrating a relationship between the charge/discharge cycle number and a capacity depending on a charge/discharge condition in Example 1 and Comparative Example 1, respectively; and

FIG. 3C is a graph illustrating capacity values in Examples 1, 1-2, 1-3, 1-4 and 1-5.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The above objects, other objects, features, and advantages of the present invention will be easily understood through the following preferred embodiments with reference to the accompanying drawings. The present invention is not limited to the embodiments described therein and may also be implemented in various different ways. On the contrary, embodiments introduced herein are provided to make disclosed contents thorough and complete and sufficiently transfer the spirit of the present invention to those skilled in the art.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprise”, “include”, “have”, etc. when used in this specification, specify the presence of stated features, regions, integers, steps, operations, elements and/or components but do not preclude the presence or addition of one or more other features, regions, integers, steps, operations, elements, components, and/or combinations thereof.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, a detailed description will be given of an exemplary composite material and method of fabricating the same according to various exemplary embodiments of the present invention with reference to the appended drawings.

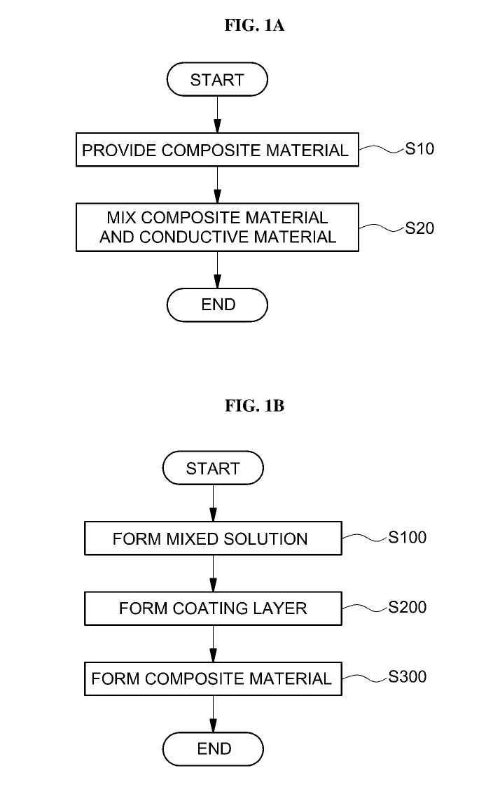

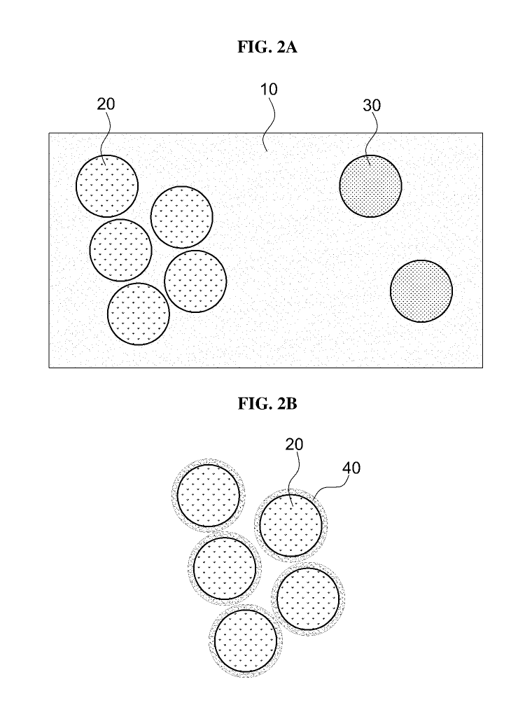

FIG. 1A is a flowchart schematically illustrating an exemplary fabrication method of an exemplary cathode for an exemplary all solid cell (e.g., all-solid battery) according to an exemplary embodiment of the present invention.

As shown in FIG. 1A, a fabrication method of a cathode for an all solid cell a may include providing a composite material that may include a cathode active material and a solid electrolyte (S₁₀) and mixing a conductive material with the composite material based on the cathode active material and the solid electrolyte at a wt % ratio of about 1 to 2:0.3 (S20). The composite material including the cathode active material and the solid electrolyte (S10) will be described below in more detail.

The conductive material is not particularly limited as long as the conductive material is generally used, and for example, may include carbon. When the wt % ratio of the composite material to the conductive material is less than about 1:0.3, the amount of the composite material may not be sufficient and thus, a lithium ion channel between the cathode active material and the solid electrolyte may not be sufficiently secured, and when the wt % ratio is greater than about 2:0.3, the amount of the conductive material may not be sufficient, and thus, the function as the cathode may be deteriorated.

FIG. 1B is a flowchart schematically illustrating an exemplary fabrication method of an exemplary composite material including a cathode active material and a solid electrolyte according to an exemplary embodiment of the present invention.

As shown in FIGS. 1A and 1B, the composite material including the cathode active material and the solid electrolyte (S10) may include forming an admixture including Li₂S, P₂S₅, and a solvent component (S100). In particular, in S100, P₂S₅ may be admixed in the solvent component. Subsequently, the admixture may be dried (S200). Particularly, a portion of the Li₂S may form particles and a remaining portion of the Li₂S and the P₂S₅ may form a coating layer on a surface of the Li₂S particles. The method may include, after forming the coating layer, heat-treating the Li₂S particles formed with the coating layer at a temperature of about 200 to 600° C. (S300). As consequence, the composite material having a core-shell structure may be formed. In particular, the composite material may include the cathode active material, i.e. the Li₂S particles, as a core, and the solid electrolyte, i.e. at least one of Li₇P₃S₁₁, Li₃PS_{4,} and Li₄P₂S₆, as a shell.

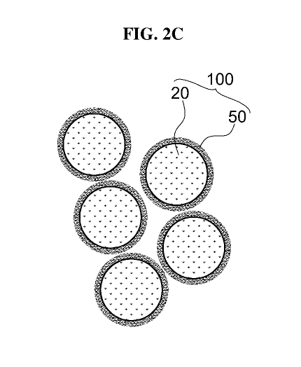

FIGS. 2A, 2B, and 2C are sequentially illustrating a fabrication method of an exemplary composite material based on an exemplary cathode active material and an exemplary solid electrolyte according to an exemplary embodiment of the present invention.

As shown in FIGS. 1B and 2A, the admixture comprising Li₂S and P₂S₅ to the solvent component, in which P₂S₅ may be admixed in the solvent component, may be formed (S100).

In the solvent component, Li₂S may not be dissolved or admixed. As shown in FIG. 2A, Li₂S may form particles, without limitation to a spherical shape, but the present invention is not limited thereto, and the Li₂S particles may have various shapes such as linear, spherical, and needle-like shapes.

In the forming of the admixture (S100), the solvent component may suitably be, for example, 1-propanol. However, the present invention is not limited thereto, and the solvent component is not particularly limited as long as the solvent component admixes only P₂S₅ of Li₂S and P₂S₅.

In the forming of the admixture (S100), the solvent component, Li₂S and P₂S₅ may be stirred at a temperature of about 30 to 60° C. for about 5 to 24 hours. When the range is less than the above range, for example, the temperature is less than about 30° C. or the time of stirring is less than about 5 hours, the P₂S₅ may not be sufficiently dissolved in the solvent component, and when the range is greater than the above range, for example, the temperature is greater than about 60° C. or the time of stirring is greater than about 24 hours, the efficiency of obtaining the admixture may not be efficiently obtained compared to the provided energy.

In the forming of the admixture (S100), the wt % ratio of Li₂S and P₂S₅ may be about 90:10 to 99:1. When the wt % ratio of Li₂S and P₂S₅ is less than about 90:10, the amount of Li₂S may not be sufficient and thus, the composite material may not be sufficiently obtained in step to be described below, and when the wt % ratio of Li₂S and P₂S₅ is greater than about 99:1, the amount of P₂S₅ compared to Li₂S used as the core may not be sufficient to form a coating layer.

The admixture (S100) may further include LiCl. Then, the solvent component may admix the P₂S₅ and the LiCl. Likewise, in the solvent component, Li₂S may not be dissolved.

As shown in FIGS. 1B and 2B, the coating layer including the remaining portion or small portion of Li₂S and the P₂S₅ may be formed on the surface of Li₂S particles by drying the admixture (S200). The admixture may be suitably dried at a temperature of about 60 to 80° C. for about 12 to 24 hours. When the range is less than the above range, for example, the temperature is less than about 60° C. or the time of stirring is less than about 12 hours, the solvent component 10 (FIG. 2A) may not be sufficiently removed, and when the range is greater than the above range, for example, the temperature is greater than about 80° C. or the time of stirring is greater than about 24 hours, removing the solvent component 10 (FIG. 2A) may not be efficient compared to the provided energy. In addition, only when the temperature during drying is within the above range, the phase transition may not occur, and only when the drying time is within the above range, the remaining organic material may be removed as much as possible. Since the remaining organic material may act as an impurity, it may be difficult to express the characteristics of the cathode active material.

In the present invention, the coating layer may be formed on the surface of Li₂S by a solution synthesis method. Preferably, in the coating layer, a layer of a small portion of Li₂S and the P₂S₅ may be formed on the surface of Li₂S particles, and Li₂S and P₂S₅ may not be coupled to each other.

When LiCl is further provided in the forming of the admixture (S100), in the forming of the coating layer (S200), the coating layer including the Li₂S, the P₂S₅ and the LiCl may be formed on the surface of Li₂S particles. In this case, in the coating layer, a layer of the Li₂S, the P₂S₅ and the LiCl may be formed on the surface of Li₂S particles, and the Li₂S, the P₂S₅ and the LiCl may not be coupled to each other.

As shown in FIGS. 1B and 2C, the Li₂S particles formed with the coating layer may be heat-treated at a temperature of about 200 to 600° C. to form the composite material having a core-shell structure including the cathode active material in the core and the solid electrolyte in the shell. Preferably, the composite material may include the Li₂S particles as the core and at least one of Li₇P₃S₁₁, Li₃PS₄, and Li₄P₂S₆ as the shell (S300). Preferably, Li₂S may function as the cathode active material.

In this case, the shell may include at least one compound of Li₇P₃S₁₁, Li₃PS_{4,} and Li₄P₂S₆ which may be formed by coupling the Li₂S and the P₂S₅ to each other. The shell may be a solid electrolyte. Preferably, at least one compound of Li₇P₃S₁₁, Li₃PS₄, and Li₄P₂S₆ which may be formed by coupling Li₂S and P₂S₅ to each other may function as a solid electrolyte.

When LiCl is further provided in the forming of the admixture (S100), in the forming of the composite material based on the cathode active material and the solid electrolyte (S300), the composite material including the cathode active material and the solid electrolyte, for example, the Li₂S particles as the core and at least one of Li₇P₃S₁₁, Li₃PS₄, Li₄P₂S₆, and Li₆PS₅Cl as the shell, may be formed.

According to various exemplary fabrication methods of the exemplary composite materials including the cathode active material and the solid electrolyte and various exemplary fabrication methods of the exemplary cathode for the all solid cell including the same according to the embodiment of the present invention, performance of the cell may be maintained by uniformly forming an interface between the cathode active material and the solid electrolyte. Further, a charge/discharge capacity of the cell may be improved by increasing a contact area between the cathode active material and the solid electrolyte. Moreover, the content of the cathode active material may increase compared to a unit area of the cathode. Although the cathode active material has any shape other than a specific shape, the composite material based on the cathode active material and the solid electrolyte having a core-shell structure may be fabricated on a simplified process by a solution synthesis method.

Hereinafter, the present invention will be described in more detail through detailed Examples. The following Examples are just exemplified for helping in understanding the present invention and the scope of the present invention is not limited thereto.

### EXAMPLES

### Examples 1 to 7

Fabrication of Composite Material Based on Cathode Active Material and Solid Electrolyte

1-propanol was used as a polar solvent, and Li₂S and P₂S₅ were added to the polar solvent. A wt % ratio of Li₂S and P₂S₅ was 95:5. After P₂S₅ was admixed through stirring, a coating layer of a small amount of Li₂S and P₂S₅ was formed on the surface of Li₂S particles through a drying process. The mixture was heat-treated at a temperature illustrated in Table 1 below to form a composite material based on a cathode active material and a solid electrolyte having a core-shell structure. Compounds constituting the shell were illustrated in Table 1 below.

Fabrication of Cathode Powder

The fabricated composite material based on the cathode active material and the solid electrolyte was mixed with a conductive material for 30 minutes. In this case, a wt % ratio of the composition material and the conductive material was 3:0.3.

Fabrication of All Solid Cell

The cathode powder was sufficiently mixed and then used to fabricate a cathode, and an all solid cell was formed by using Li₆PS₅Cl as a solid electrolyte layer and lithium-indium (Li—In) as an anode.

### Comparative Example 1

Except for using ethyl acetate instead of 1-propanol, an all solid cell was fabricated in the same manner as Example 1. In Comparative Example 1, a coating layer was not formed on the surface of Li₂S and thus, a core-shell structure was not formed.

### Comparative Example 2

Except for using acetonitrile instead of 1-propanol, an all solid cell was fabricated in the same manner as Example 1. In Comparative Example 2, a coating layer was not formed on the surface of Li₂S and thus, a core-shell structure was not formed.

TABLE 1

| | Heat-treatment temperature | Composition of electrolyte |
|---|---|---|
| Example 1 | 260 | Li₇P₃S₁₁ |
| Example 2 | 200 | Li₃PS₄ |
| Example 3 | 220 | Li₇P₃S₁₁ + Li₄P₂S₆ |
| Example 4 | 240 | Li₇P₃S₁₁ |
| Example 5 | 260 | Li₇P₃S₁₁ |
| Example 6 | 280 | Li₇P₃S₁₁ + Li₄P₂S₆ |
| Example 7 | 300 | Li₇P₃S₁₁ + Li₄P₂S₆ |

Evaluation of Properties

1. Evaluation of Discharge Capacity

Table 2 below illustrates an initial discharge capacity in Examples 1 to 7 and Comparative Examples 1 and 2. Referring to Table 2 below, it can be seen that the initial discharge capacities in Examples 1 to 7 are higher than the initial discharge capacities in Comparative Examples 1 and 2.

TABLE 2

| | Initial discharge capacity |
|---|---|
| | (mAh/g) |
| Example 1 | 601.56 |
| Example 2 | 481.51 |
| Example 3 | 520.36 |
| Example 4 | 568.68 |
| Example 5 | 601.56 |
| Example 6 | 510.32 |
| Example 7 | 502.54 |
| Comparative Example 1 | 130.58 |
| Comparative Example 2 | 105.48 |

2. Evaluation of Cell Performance

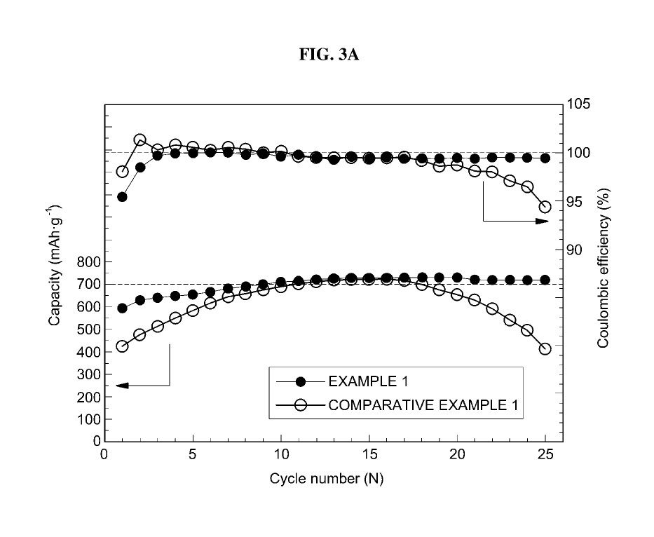

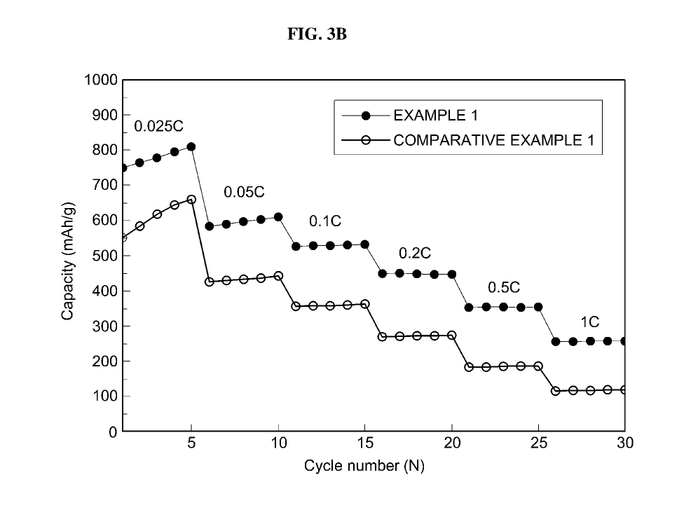

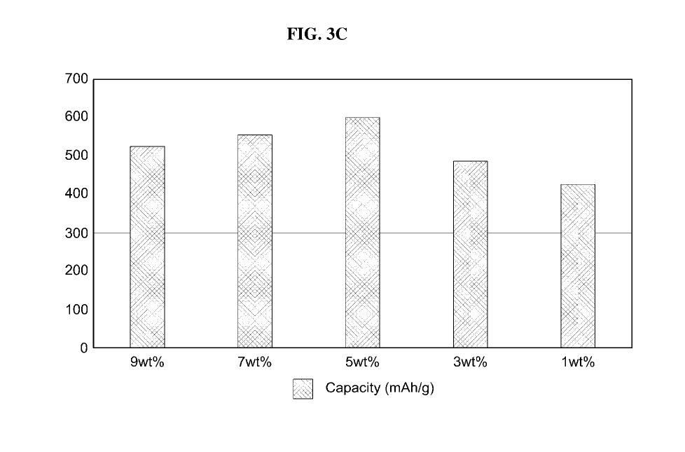

FIG. 3A is a graph illustrating a relationship between the charge/discharge cycle number and a capacity and a relationship between the charge/discharge cycle number and coulombic efficiency in Example 1 and Comparative Example 1, respectively. As shown in FIG. 3A, in Comparative Example, the capacity and the coulombic efficiency were decreased according to the charge/discharge cycle number, but in Example 1, the capacity and the coulombic efficiency were maintained.

FIG. 3B is a graph illustrating a relationship between the charge/discharge cycle number and a capacity depending on a charge/discharge condition in Example 1 and Comparative Example 1, respectively. In Example 1, the capacity value according to the charge/discharge cycle number was greater than that of Comparative Example 1 under different charge/discharge conditions.

### Examples 1-2 to 1-5

Except that the wt % ratio of Li₂S and P₂S₅ was different as illustrated in Table 3 below in the fabrication of the composite material based on the cathode active material and the solid electrolyte, an all solid cell was fabricated in the same manner as Example 1. The capacity for each all solid cell was measured and the result thereof was illustrated in FIG. 3C.

TABLE 3

| | Wt % of Li₂S and P₂S₅ |
|---|---|
| Example 1 | Li₂S: 95, P₂S₅: 5 |
| Example 1-2 | Li₂S: 99, P₂S₅: 1 |
| Example 1-3 | Li₂S: 97, P₂S₅: 3 |
| Example 1-4 | Li₂S: 93, P₂S₅: 7 |
| Example 1-5 | Li₂S: 91, P₂S₅: 9 |

Generally, in the related art, when the capacity value is 400 mAh/g or more, it is meant that the all solid cell has an excellent charge/discharge capacity. As shown in FIG. 3C, t the all solid cells in Examples 1 to 1-5 had all the capacity value of 400 mAh/g or greater and thus had the excellent charge/discharge capacity.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method of fabricating a composite material, comprising:
preparing an admixture comprising 1) Li₂S and P₂S₅, and 2) a solvent component, wherein the P₂S₅ is admixed in the solvent component;
drying the admixture, wherein a portion of the Li₂S forms particles and a remaining portion of the Li₂S and the P₂S₅ form a coating layer on a surface of the Li₂S particles; and
heat-treating the Li₂S particles formed with the coating layer to form the composite material wherein the composite material has a core-shell structure and comprises the Li₂S as a core and at least one of Li₇P₃S₁₁, Li₃PS₄, and Li₄P₂S₆ as a shell.

2. The method of claim 1, wherein the solvent component is one or more polar solvent.

3. The method of claim 2, wherein the one or more polar solvent are selected from solvents that comprises alcohols, esters or amides.

4. The method of claim 1, wherein the solvent component comprises 1-propanol.

5. The method of claim 1, wherein the heat-treating is performed at a temperature of about 200 to 600° C.

6. The method of claim 1, wherein a wt % ratio of Li₂S and P₂S₅ in the admixture is from about 90:10 to about 99:1.

7. The method of claim 1, wherein the admixture is prepared by stirring the solvent component, Li₂S and P₂S₅ at a temperature of about 30 to 60° C. for about 5 to 24 hours.

8. The method of claim 1, wherein the admixture further comprises LiCl, and the P₂S₅ and the LiCl are admixed in the solvent component.

9. The method of claim 8, wherein the coating layer comprising the Li₂S, the P₂S₅, and the LiCl is formed on the surface of the Li₂S particles, and the composite material comprises the Li₂S as a core and at least one of the Li₇P₃S₁₁, the Li₃PS₄, the Li₄P₂S₆, Li₆PS₅Cl as a shell.

10. The method of claim 9, wherein the core comprises a cathode active material and the shell comprises a solid electrolyte.

11. A method of fabricating a cathode for an all solid cell, comprising:
providing a composite material of claim 1; and
mixing a conductive material with the composite material.

12. The method of claim 11, wherein the conductive material is mixed with the composite material at a wt % ratio from about 1:0.3 to about 2:0.3.

13. A cathode material for an all-solid battery, comprising:
1) a composite material obtainable by the method of claims 1; and
2) a conductive material.

14. An all-solid battery comprising a composite material of claim 1.

15. A vehicle comprising an all-solid battery of claim 14.
